(19) United States
(12) Patent Application Publication
(10) Pub. No.: US 2010/0281207 A1
(43) Pub. Date: Nov. 4, 2010

(54) FLASH-BASED DATA ARCHIVE STORAGE SYSTEM

(76) Inventors: Steven C. Miller, Livermore, CA (US); Don Trimmer, Sunnyvale, CA (US); Steven R. Kleiman, Los Altos, CA (US)

Correspondence Address: CESARI AND MCKENNA, LLP, 88 BLACK FALCON AVENUE, BOSTON, MA, 02210, US

(21) Appl. No.: 12/754,137

(22) Filed: Apr. 5, 2010

Related U.S. Application Data
(60) Provisional application No. 61/174,295, filed on Apr. 30, 2009.

(51) Int. Cl. G06F 12/00; G06F 12/16; G06F 17/00

(52) U.S. Cl. 711/103; 711/161; 707/661; 711/E12.001; 711/E12.008; 707/E17.044

(57) ABSTRACT

A flash-based data archive storage system having a large capacity storage array constructed from a plurality of dense flash devices is provided. The flash devices are illustratively multi-level cell (MLC) flash devices that are tightly packaged to provide a low-power, high-performance data archive system having substantially more capacity per cubic inch than more dense tape or disk drives. The flash-based data archive system may be adapted to employ conventional data de-duplication and compression methods to compactly store data. Furthermore, the flash-based archive system has a smaller footprint and consumes less power than the tape and/or disk archive system.

### RELATED APPLICATION

The present invention claims priority from U.S. Provisional Application Ser. No. 61/174,295, filed on Apr. 30, 2009 for FLASH BASED DATA ARCHIVE STORAGE SYSTEM, by Steven C. Miller, et al., the contents of which are incorporated herein by reference.

### FIELD OF THE INVENTION

The present invention relates to storage systems and, more specifically, to data archive storage systems.

### BACKGROUND OF THE INVENTION

A storage system is a computer that provides storage service relating to the organization of data on writable persistent storage media, such as non-volatile memories and disks. The storage system may be configured to operate according to a client/server model of information delivery to thereby enable many clients (e.g., applications) to access the data served by the system. The storage system typically employs a storage architecture that serves the data in both file system and block formats with both random and streaming access patterns. Disks generally provide good streaming performance (e.g., reading of large sequential blocks or “track reads”) but do not perform well on random access (i.e., reading and writing of individual disk sectors). In other words, disks operate most efficiently in streaming or sequential mode, whereas small random block operations can substantially slow the performance of disks.

A data archive storage system, such as a tape or disk system, is typically constructed from large, slow tape or disk drives that are accessed (e.g., read or written) infrequently over the lifetime of the devices. For example, information stored on a tape or disk archive device may typically only be accessed (i) to perform a consistency check to ensure that the archived information is still valid and/or (ii) to retrieve the archived information for, e.g., disaster or compliance purposes. Moreover, the tape or disk archive system is typically stored in an environmentally controlled area that provides sufficient floor space (footprint), safety and/or power to accommodate the system. In the case of a tape archive system, for instance, large tape robots consume and thus require a substantial footprint to accommodate swinging of mechanical arms used to access the tape drives. Similarly, a disk archive system consumes and requires a substantial footprint to accommodate cabinets used to house the disk drives. In addition, a controlled environment for these archive systems includes power sources used to provide substantial power needed for reliable operation of the drives.

The tape and disk archive systems generally employ conventional data de-duplication and compression methods to compactly store data. These systems typically distribute pieces or portions of the de-duplicated and compressed data onto different storage elements (e.g., on different disk spindles or different tapes) and, thus, require collection of those distributed portions to re-create the data upon access. The portions of the data are distributed among the different elements because data typically just accumulates, i.e., is not deleted, on the archive system. That is, all possible versions of data are maintained over time for compliance (e.g., financial and/or medical record) purposes.

In the case of de-duplication, a data container (such as a file) may be sliced into many portions, each of which may be examined to determine whether it was previously stored on the archive system. For example, a fingerprint may be provided for each portion of the file and a database may be searched for that fingerprint. If the fingerprint is found in the database, only a reference to that database fingerprint (i.e., to the previously stored data) is recorded. However, if the fingerprint (portion of the file) is not in the database (not previously stored), that portion is stored on the system and possibly on a different element of the system (the fingerprint for that portion is also stored in the database).

Assume a request is provided to the archive system to retrieve a particular version of the archived file. In the case of a tape archive system, multiple tapes may have to be read to retrieve all portions of the file, which is time consuming. In case of a disk archive system, many disk drives may need to be powered and read to retrieve all portions of the file. Here, there may be a limit to the number of disks that can be powered up and running at a time. In addition, a finite period of time is needed to sequence through all the disks.

### SUMMARY OF THE INVENTION

The present invention overcomes the disadvantages of the prior art by providing a flash-based data archive storage system having a large capacity storage array constructed from a plurality of dense flash devices, i.e., flash devices capable of storing a large quantity of data in a small form factor. The flash devices are illustratively multi-level cell (MLC) flash devices that are tightly packaged to provide a low-power, high-performance data archive system having substantially more capacity per cubic inch than more dense tape or disk drives. The flash-based data archive system may be adapted to employ conventional data de-duplication and compression methods to compactly store data. However, unlike conventional tape and disk archive systems, the access performance of MLC flash devices is substantially faster because the storage media is electronic memory. That is, there is no spin-up time needed for the electronic memory as with magnetic disk drives, i.e., power is supplied to the MLC devices, data is retrieved and power to the devices is then turned off. Performance of the flash-based archive system is substantially better than any mechanical or electromechanical device based system. Furthermore, the flash-based archive system has a smaller footprint and consumes less power than the tape and/or disk archive system.

Advantageously, the use of flash devices for a data archive system does not require an environmentally controlled area for operation. That is, the flash devices are solid-state semiconductor devices that do not require nor consume substantial floor space and/or power compared to tape and/or disk archive systems. Moreover, power need only be provided to those flash devices being accessed, i.e., power to the other semiconductor devices of the system can remain off. In addition, the flash-based archive system provides higher performance than a disk drive archive system because random access to data stored on the flash devices is fast and efficient.

In operation, a data set is transmitted to the data archive storage system. The received data set is de-duplicated and compressed prior to being stored on an array of electronic storage media, e.g., MLC flash devices. When the data archive storage system receives a data access request to retrieve (read) data from the data archive, the storage system first identifies those devices on which the requested data is stored. The identified devices are then powered up and the data read from them. The data is then decompressed and restored before being returned to the requestor. The devices are then powered down.

### BRIEF DESCRIPTION OF THE DRAWINGS

The above and further advantages of the invention may be better understood by referring to the following description in conjunction with the accompanying drawings in which like reference numerals indicate identical or functionally similar elements:

FIG. 1 is a schematic block diagram of an environment including a storage system that may be advantageously used in accordance with an illustrative embodiment of the present invention;

FIG. 2 is a schematic block diagram of a storage operating system that may be advantageously used in accordance with an illustrative embodiment of the present invention;

FIG. 3 is a schematic block diagram illustrating organization of a storage architecture that may be advantageously used in accordance with an illustrative embodiment of the present invention;

FIG. 4 is a flow chart detailing the steps of a procedure for storing data on a data archive storage system in accordance with an illustrative embodiment of the present invention;

FIG. 5 is a flow chart detailing the steps of a procedure for performing data de-duplication in accordance with an illustrative embodiment of the present invention; and

FIG. 6 is a flowchart detailing the steps of a procedure for reading data from a data archive storage system in accordance with an illustrative embodiment of the present invention.

### DETAILED DESCRIPTION OF ILLUSTRATIVE EMBODIMENTS

### A. Data Archive Environment

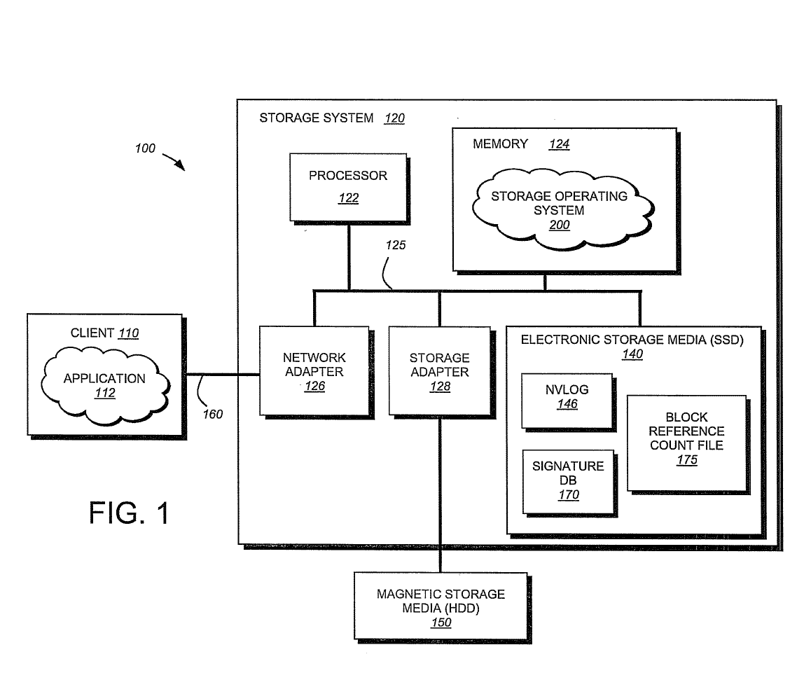

FIG. 1 is a schematic block diagram of an environment 100 including a storage system that may be configured to provide a data archive storage system of the present invention. The storage system 120 is a computer that provides storage services relating to the organization of information on writable, persistent electronic and magnetic storage media. To that end, the storage system 120 comprises a processor 122, a memory 124, a network adapter 126, a storage adapter 128 and electronic storage media 140 interconnected by a system bus 125. The storage system 120 also includes a storage operating system 200 that implements a virtualization system to logically organize the information as a hierarchical structure of data containers, such as files and logical units (luns), on the electronic and magnetic storage media 140, 150.

The memory 124 comprises storage locations that are addressable by the processor and adapters for storing software programs and data structures associated with the embodiments described herein. The processor and adapters may, in turn, comprise processing elements and/or logic circuitry configured to execute the software programs and manipulate the data structures. The storage operating system 200, portions of which are typically resident in memory and executed by the processing elements, functionally organizes the storage system by, inter alia, invoking storage operations in support of software processes executing on the system. It will be apparent to those skilled in the art that other processing and memory means, including various computer readable media, may be used to store and execute program instructions pertaining to the embodiments described herein.

The electronic storage media 140 is illustratively configured to provide a persistent, storage space capable of maintaining data, e.g., in the event of a power loss to the storage system. Accordingly, the electronic storage media 140 may be embodied as a large-volume, random access memory array of solid-state devices (SSDs) having either a back-up battery, or other built-in last-state-retention capabilities (e.g., a flash memory), that holds the last state of the memory in the event of any power loss to the array. The SSDs may comprise flash memory devices (“flash devices”), which are illustratively block-oriented semiconductor devices having good read performance, i.e., read operations to the flash devices are substantially faster than write operations, primarily because of their storage model. Types of flash devices include a single-level cell (SLC) flash device that stores a single bit in each cell and a multi-level cell (MLC) flash device that stores multiple bits (e.g., 2, 3 or 4 bits) in each cell. Although a MLC flash device is denser than a SLC device, the ability to constantly write to the MLC flash device, e.g., before wear-out, is substantially more limited than for the SLC device. Portions of the electronic storage media are illustratively organized as a non-volatile log (NVLOG 146) used to temporarily store (“log”) certain data access operations, such as write operations, that are processed by the virtualization system prior to storing the data associated with those operations to the electronic and/or magnetic storage media during a consistency model event, e.g., a consistency point (CP), of the system. CPs are described in U.S. Pat. No. 5,819,292, issued Oct. 6, 1998, entitled Method for Maintaining Consistent States of a File System and for Creating User-Accessible Read-Only Copies of a File System, by David Hitz, et al., the contents of which are hereby incorporated by reference. Furthermore, in an illustrative embodiment of the present invention, the electronic storage media may store a signature database 170 and a block reference count data structure, illustratively organized as a file 175. The signature database 170 and block count reference file 175 are illustratively utilized to perform de-duplication operations, described further below, on data being written to the data archive storage system.

The network adapter 126 comprises the mechanical, electrical and signaling circuitry needed to connect the storage system 120 to a client 110 over a computer network 160, which may comprise a point-to-point connection or a shared medium, such as a local area network. The client 110 may be a general-purpose computer configured to execute applications 112, such as a database application. Moreover, the client 110 may interact with the storage system 120 in accordance with a client/server model of information delivery. That is, the client may request the services of the storage system, and the system may return the results of the services requested by the client, by exchanging packets over the network 160. The clients may issue packets including file-based access protocols, such as the Common Internet File System (CIFS) protocol or Network File System (NFS) protocol, over TCP/IP when accessing information in the form of files. Alternatively, the client may issue packets including block-based access protocols, such as the Small Computer Systems Interface (SCSI) protocol encapsulated over TCP (iSCSI), SCSI encapsulated over FC (FCP), SCIS over FC over Ethernet (FCoE), etc., when accessing information in the form of luns or blocks.

The storage adapter 128 cooperates with the storage operating system 200 executing on the storage system to manage access to magnetic storage media 150, which is illustratively embodied as hard disk drives (HDDs). The storage adapter includes input/output (I/O) interface circuitry that couples to the HDDs over an I/O interconnect arrangement, such as a conventional high-performance, Fibre Channel serial link topology. The information is retrieved by the storage adapter and, if necessary, processed by the processor 122 (or the adapter 128) prior to being forwarded over the system bus 125 to the network adapter 126, where the information is formatted into a packet and returned to the client 110. Illustratively, the data archive storage system utilizes the electronic media for storage of data. However, in alternative embodiments, a hybrid media architecture comprising of HDDs and SSDs may be utilized. An example of a hybrid media architecture that may be advantageously used is described in U.S. Provisional Patent Application No. 61/028,107, filed on Feb. 12, 2008, entitled Hybrid Media Storage System Architecture, by Jeffrey S. Kimmel, et al., the contents of which are hereby incorporated by reference.

### B. Storage Operating System

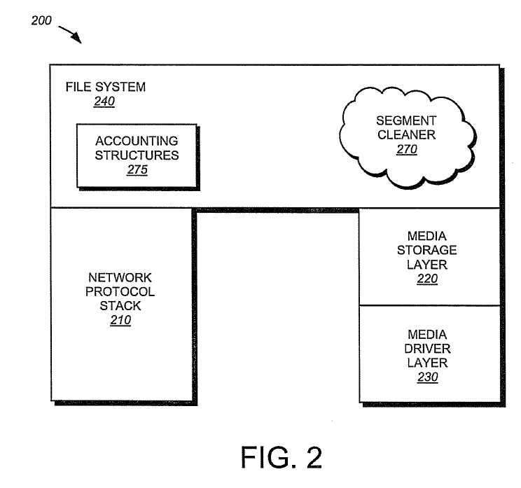

FIG. 2 is a schematic block diagram of the storage operating system 200 that may be advantageously used with the present invention. The storage operating system comprises a series of modules, including a network driver module (e.g., an Ethernet driver), a network protocol module (e.g., an Internet Protocol module and its supporting transport mechanisms, the Transport Control Protocol module and the User Datagram Protocol module), as well as a file system protocol server module (e.g., a CIFS server, a NFS server, etc.) organized as a network protocol stack 210. In addition, the storage operating system 200 includes a media storage module 220 that implements a storage media protocol, such as a Redundant Array of Independent (or Inexpensive) Disks (RAID) protocol, and a media driver module 230 that implements a storage media access protocol such as, e.g., a Small Computer Systems Interface (SCSI) protocol. As described herein, the media storage module 220 may alternatively be implemented as a parity protection (RAID) module and embodied as a separate hardware component, such as a RAID controller.

Bridging the storage media software modules with the network and file system protocol modules is a virtualization system that may be embodied as a file system 240. Although any type of file system may be utilized, in an illustrative embodiment, the file system 240 utilizes a data layout format and implements data layout techniques as described further herein.

As used herein, the term “storage operating system” generally refers to the computer-executable code operable on a computer to perform a storage function that manages data access and may, in the case of a storage system 120, implement data access semantics of a general purpose operating system. The storage operating system can also be implemented as a microkernel, an application program operating over a general-purpose operating system, such as UNIX® or Windows NT®, or as a general-purpose operating system with configurable functionality, which is configured for storage applications as described herein.

In addition, it will be understood to those skilled in the art that the invention described herein may apply to any type of special-purpose (e.g., file server, filer or storage serving appliance) or general-purpose computer, including a standalone computer or portion thereof, embodied as or including a storage system. Moreover, the teachings of this invention can be adapted to a variety of storage system architectures including, but not limited to, a network-attached storage environment, a storage area network and disk assembly directly-attached to a client or host computer. The term “storage system” should therefore be taken broadly to include such arrangements in addition to any subsystems configured to perform a storage function and associated with other equipment or systems.

Data stored on a flash device are accessed (e.g., via read and write operations) in units of pages, which are illustratively 4 kilobyte (KB) in size, although other page sizes (e.g., 2 KB) may also be advantageously used with the present invention. To rewrite previously written data on a page, the page must be erased; yet in an illustrative embodiment, the unit of erasure is a block comprising a plurality of (e.g., 64) pages, i.e., a “flash block” having a size of 256 kB. Therefore, even though data stored on the device can be accessed (read and written) on a page basis, clearing or erasing of the device takes place on a block basis. A reason for the slow write performance of a flash device involves management of free space in the device, i.e., if there is not sufficient storage space to accommodate write operations to pages of a block, valid data must be moved to another block within the device, so that the pages of an entire block can be erased and freed for future allocation. Such write behavior of the flash device typically constrains its effectiveness in systems where write performance is a requirement.

### C. Storage Architecture

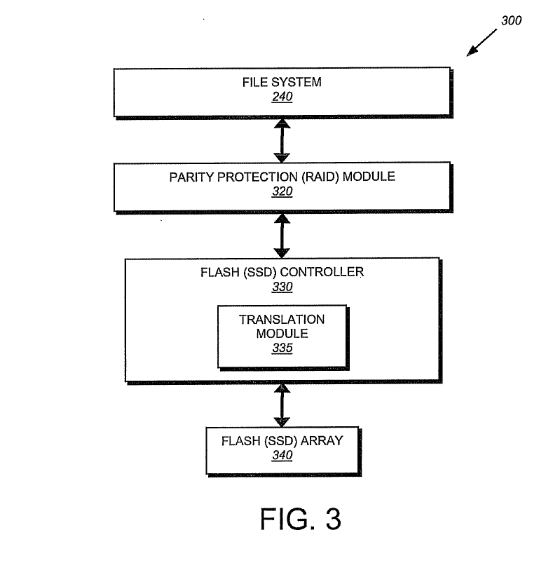

FIG. 3 is a schematic block diagram illustrating organization of an exemplary media storage architecture 300 that may be utilized in accordance with an illustrative embodiment of data archive storage system of the present invention. The architecture includes the file system 240 disposed over a parity protection (RAID) module 320 to control operation of the SSDs of flash array 340 to provide a total storage space of the storage system 120. A flash (SSD) controller 330 implements a storage protocol for accessing its respective media (flash or disk, respectively). As described further herein, each SSD of the array 340 has an associated translation module 335 that is illustratively provided by the SSD controller 330a.

The SSD controller 330 exports geometry information to the RAID module 320, wherein the geometry information comprises a model type of device and the size (number of blocks) of the device, e.g., in terms of device block numbers (dbns) for use by the module 320. In the case of the flash array 340, a dbn is illustratively a logical address that the SSD controller 330 presents to the RAID module and that is subject to translation mapping inside the SSD to a flash physical address. The SSD controller illustratively presents a 512 byte per sector interface, which may be optimized for random write access at block sizes of, e.g., 4 KB.

The file system 240 illustratively implements data layout techniques that improve read and write performance to flash array 340 of electronic storage media 140. For example, the file system utilizes a data layout format that provides fast write access to data containers, such as files, thereby enabling efficient servicing of random (and sequential) data access operations directed to the flash array 340. To that end, the file system illustratively implements a set of write anywhere algorithms to enable placement of data anywhere in free, available space on the SSDs of the flash array 340.

Since the flash array 340 is illustratively constructed of SSDs, random access is consistent (i.e., not based on mechanical positioning, as with HDDs). Accordingly, the file system 240 cooperates with the SSDs to provide a data layout engine for the flash array 340 that improves write performance without degrading the sequential read performance of the array.

In an illustrative embodiment, the file system 240 is a message-based system having a format representation that is block-based using, e.g., 4 KB blocks and using index nodes (“inodes”) to describe the data containers, e.g., files. As described herein, file system implements an arbitrary per object store (e.g., file block number) to physical store (e.g., physical volume block number) mapping. The granularity of mapping is illustratively block-based to ensure accommodation of small allocations (e.g., 4 KB) to fill in the available storage space of the media. However, it will be understood those skilled in the art that the media storage architecture should be applicable to any kind of object that is implemented on storage and that implements translation sufficient to provide fine granularity to accommodate block-based placement.

The file system also illustratively uses data structures to store metadata describing its layout on storage devices of the arrays. The file system 240 provides semantic capabilities for use in file-based access to information stored on the storage devices, such as the SSDs of flash array 340. In addition, the file system provides volume management capabilities for use in block-based access to the stored information. That is, in addition to providing file system semantics, the file system 240 provides functions such as (i) aggregation of the storage devices, (ii) aggregation of storage bandwidth of the devices, (iii) reliability guarantees, such as minoring and/or parity (RAID) and (iv) thin-provisioning.

As for the latter, the file system 240 further cooperates with the parity protection (RAID) module 320, e.g., of media storage module 220, to control storage operations to the flash array 340. In the case of the flash array 340, there is a hierarchy of reliability controls illustratively associated with the SSDs of the array. For example, each SSD incorporates error correction code (ECC) capabilities on a page basis. This provides a low level of reliability control for the page within a flash block. A higher level of reliability control is further implemented when embodying flash blocks within a plurality of SSDs to enable recovery from errors when one or more of those devices fail.

The high level of reliability control is illustratively embodied as a redundancy arrangement, such as a RAID level implementation, configured by the RAID module 320. Storage of information is preferably implemented as one or more storage volumes that comprise one or more SSDs cooperating to define an overall logical arrangement of volume block number space on the volume(s). Here, the RAID module 320 organizes the SSDs within a volume as one or more parity groups (e.g., RAID groups), and manages parity computations and topology information used for placement of data on the SSDs of each group. The RAID module further configures the RAID groups according to one or more RAID implementations, e.g., a RAID 1, 4, 5 and/or 6 implementation, to thereby provide protection over the SSDs in the event of, e.g., failure to one or more SSDs. That is, the RAID implementation enhances the reliability/integrity of data storage through the writing of data “stripes” across a given number of SSDs in a RAID group, and the appropriate storing of redundant information, e.g., parity, with respect to the striped data.

In the case of the flash array 340, the RAID module 320 illustratively organizes a plurality of SSDs as one or more parity groups (e.g., RAID groups), and manages parity computations and topology information used for placement of data on the devices of each group. To that end, the RAID module further organizes the data as stripes of blocks within the RAID groups, wherein a stripe may comprise correspondingly located flash pages across the SSDs. That is, a stripe may span a first page 0 on SSD 0, a second page 0 on SSD 1, etc. across the entire RAID group with parity being distributed among the pages of the devices. Note that other RAID group arrangements are possible, such as providing a logical RAID implementation wherein every predetermined (e.g., 8^{th}) block in a file is a parity block.

The volumes may be embodied as virtual volumes and further organized as one or more aggregates of, e.g., the flash array 340 and disk array 350. Aggregates and virtual volumes are described in U.S. Pat. No. 7,409,494, issued on Aug. 5, 2008, entitled Extension of Write Anywhere File System Layout, by John K. Edwards et al, the contents of which are hereby incorporated by reference. Briefly, an aggregate comprises one or more groups of SSDs, such as RAID groups, that are apportioned by the file system into one or more virtual volumes (vvols) of the storage system. Each vvol has its own logical properties, such as “point-in-time” data image (i.e., snapshot) operation functionality, while utilizing the algorithms of the file system layout implementation. The aggregate has its own physical volume block number (pvbn) space and maintains metadata, such as block allocation structures, within that pvbn space. Each vvol has its own virtual volume block number (vvbn) space and maintains metadata, such as block allocation structures, within that vvbn space.

Each vvol may be associated with a container file, which is a “hidden” file (not accessible to a user) in the aggregate that holds every block in use by the vvol. When operating on a vvol, the file system 240 uses topology information provided by the RAID module 320 to translate a vvbn (e.g., vvbn X) into a dbn location on an SSD. The vvbn identifies a file block number (fbn) location within the container file, such that a block with vvbn X in the vvol can be found at fbn X in the container file. The file system uses indirect blocks of the container file to translate the fbn into a physical vbn (pvbn) location within the aggregate, which block can then be retrieved from a storage device using the topology information supplied by the RAID module 320.

In an illustrative embodiment, the RAID module 320 exports the topology information for use by the file system 240 when performing write allocation of data, i.e., when searching for free, unallocated space in the vvbn storage space of the flash array 340. The topology information illustratively comprises pvbn-to-dbn mappings.

For the flash array 340, block allocation accounting structures used by the file system to perform write allocation are sized to accommodate writing of data to the array in the first data layout format, e.g., a sequential order. To that end, the file system 240 illustratively performs write allocation sequentially, e.g., on a 256 KB flash block basis in the array 340; i.e., the vvbn in the flash array is illustratively mapped to a 256 KB flash block. Once a flash block is erased and designated “freed” (e.g., as a free vvbn) by the storage operating system, data may be written (in accordance with write operations of a CP) sequentially through the sixty-four 4 KB pages (e.g., page 0 through page 63) in the flash block, at which time a next free flash block is accessed and write operations occur sequentially from page 0 to page 63. The accounting structures 275, e.g., free block maps, used by the file system 240 are illustratively maintained by a segment cleaning process 270 and indicate free flash blocks available for allocation.

Illustratively, segment cleaning is performed to free-up one or more selected regions that indirectly map to flash blocks. Pages of these selected regions that contain valid data (“valid pages”) are moved to different regions and the selected regions are freed for subsequent reuse. The segment cleaning consolidates fragmented free space to improve write efficiency, e.g. to underlying flash blocks. In this manner, operation of the file system 240 is leveraged to provide write anywhere capabilities, including segment cleaning, on the flash array 340. Illustratively, the segment cleaning process 270 may be embodied as a scanner that operates with a write allocator within file system to traverse (walk) buffer and inode trees when “cleaning” (clearing) the SSDs.

### D. Operation of Data Archive

Embodiments of the present invention provide a flash-based data archive storage system having a large capacity storage array constructed from a plurality of flash devices. The flash devices are illustratively multi-level cell (MLC) flash devices that are tightly packaged, e.g., into a small form factor, to provide a low-power, high-performance data archive system having more capacity per cubic inch than tape or disk drives. The flash-based data archive system may be adapted to employ conventional data de-duplication and compression methods to compactly store data. However, unlike conventional tape and disk archive systems, the access performance of MLC flash devices is faster because the storage media is electronic memory. That is, there is no spin-up time needed for the electronic memory as with magnetic disk drives, i.e., power is supplied to the MLC devices, data is retrieved and power to the devices is then turned off. Performance of the flash-based archive system is better than any mechanical or electromechanical device based system. Furthermore, the flash-based archive system has a smaller footprint and consumes less power than the tape and/or disk archive system.

Advantageously, the use of flash devices for a data archive system does not require an environmentally controlled area for operation. That is, the flash devices are solid-state semiconductor devices that do not require nor consume substantial floor space and/or power compared to tape and/or disk archive systems. Moreover, power need only be provided to those flash devices being accessed, i.e., power to the other semiconductor devices of the system can remain off. In addition, the flash-based archive system provides higher performance than a disk drive archive system because random access to data stored on the flash devices is fast and efficient.

In operation, a data set is transmitted to the data archive storage system from, e.g., a client 110. The received data set is de-duplicated and compressed, by the data archive storage system prior to being stored on an array of electronic storage media, e.g., MLC flash devices. When the data archive storage system receives a data access request to retrieve (read) data from the data archive, the SSD controller 330 first identifies those devices on which the requested data is stored. The identified devices are then powered up by the SSD controller 330 and the data read from them. The data is then decompressed and restored before being returned to the requestor. The devices are then powered down.

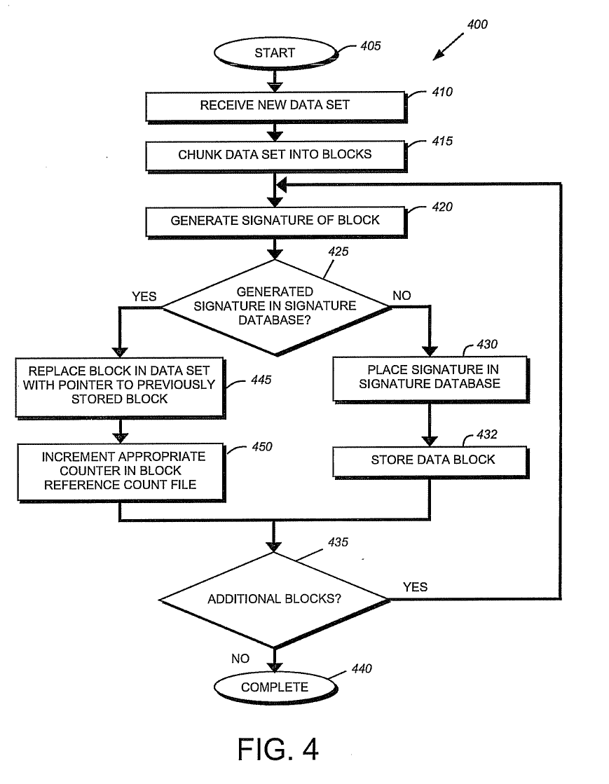

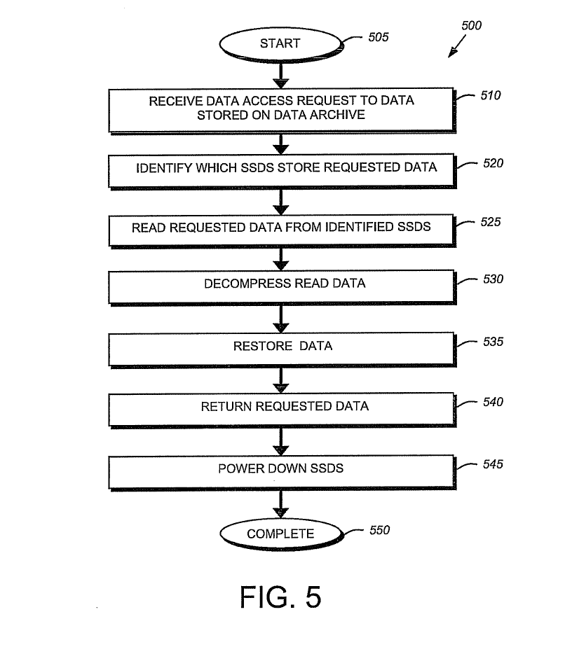

FIG. 4 is a flowchart detailing the steps of a procedure or 400 for storing data on a data archive storage system in accordance with an illustrative embodiment of the present invention. The procedure 400 begins in step 405 and continues to step 410 where a new data set to be stored on the data archive is received. Illustratively, the new data set is to be stored on the data archive for long term storage, e.g., a back up image of a file system, etc. The data set may be received using conventional file transfer protocols and/or data backup protocols directed to the data archive storage system. In an illustrative embodiment, the received data set is then de-duplicated in step 500, described below in reference to FIG. 5. It should be noted that in alternative embodiments, the data set may not be de-duplicated and/or may be de-duplicated using a technique other than that described in procedure 500. As such, the description of the data set being de-duplicated should be taken as exemplary only.

Once the data set has been de-duplicated, the data set is then compressed in step 415. The data set may be compressed using any compression technique, e.g., ZIP, LZW etc. It should be noted that in alternative embodiments, the data set may not be compressed. As such, the description of compressing the data set should be taken as exemplary only. The de-duplicated and compressed data set is then stored on the SSDs of the data archive storage system in step 420. The procedure 400 then completes in step 425.

FIG. 5 is a flowchart detailing the steps of a data de-duplication procedure 500 in accordance with an illustrative embodiment of the present invention. The procedure 500 begins in step 505 and continues to step 510 where a new data set is received by, e.g., the data archive storage system. In an illustrative embodiment, the received data set may comprise a new tape backup data stream directed to the data archive storage system. Illustratively, the file system 240 implements an illustrative de-duplication technique described below However, it should be noted that in alternative embodiments of the present invention, any data de-duplication technique may be utilized. As such, the de-duplication technique described herein should be taken as exemplary only.

In response to receiving the new data set, the file system 240 chunks (segments) the data set into blocks in step 515. The file system 240 may chunk the data set using any acceptable form of data segmentation. In an illustrative embodiment, the file system 240 chunks the data into fixed size blocks having a size of, e.g., 32 KB. However, it should be noted that in alternative embodiments additional and/or varying sizes may be utilized. Furthermore, the present invention may be utilized with other techniques for generating a blocks of data from the data set. As such, the description of utilizing fixed size blocks should be taken as exemplary only.

A signature of the block is then generated in step 520. Illustratively, the signature may be generated by hashing the data contained within the block and utilizing the resulting hash value as the signature. As will be appreciated by one skilled in the art, a strong hash function should be selected to avoid collisions, i.e., blocks having different contents hashing to the same hash value. However, it should be noted that in alternative embodiments differing techniques for generating a signature may be utilized. As such, the description of hashing the data in a block to generate the signature should be taken as exemplary only.

Once the signature of a block has been generated, the file system 240 determines whether the generated signature is located within the signature database 170 in step 525. This may be accomplished using, e.g., conventional hash table lookup techniques. If the signature is not stored within the signature database, the procedure 500 branches to step 530 where the file system 240 loads the signature within the signature database. If the signature is not within the signature database, then the block associated with the signature has not been stored previously, i.e., this is the first occurrence of the block. Additionally, the block is then stored in step 532. In step 535, a determination is made whether additional blocks are within the data set. If so, the procedure 500 loops back to step 520 where the file system 240 generates the signature of the next block in the data set. Otherwise, the procedure 500 completes in step 540.

However, if the generated signature is located within the signature database 270, the file system 240 then replaces the block in the incoming data set with a pointer to a previously stored block in step 545. That is, the file system 240 de-duplicates the data by replacing the duplicate data block with a pointer to the previously stored data block. For example, a data stream of ABA may be de-duplicated to AB<pointer to previously stored A>. As the size of the pointer is typically substantially smaller than the size of a block (typically by several orders of magnitude), substantial savings of storage space occurs. The file system 240 then increments the appropriate counter in the block to reference counter file 175 in step 550.

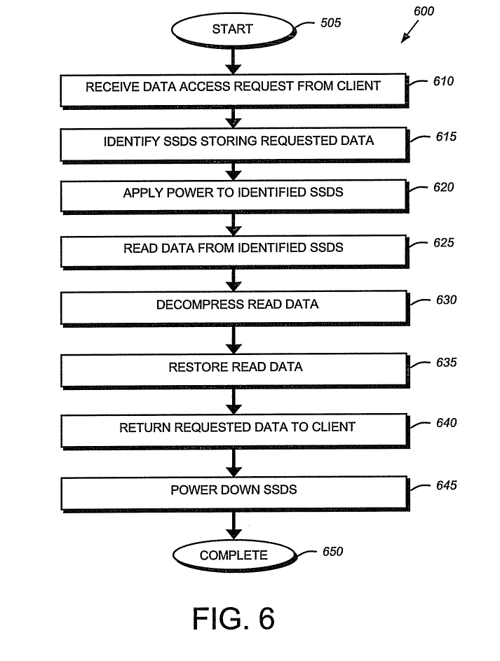

The procedure 500 continues to step 535 to determine whether any additional blocks are in the data set. If there are no additional blocks in the data set, the procedure completes in step 535. However, if there are additional blocks, the procedure loops back to step 520. FIG. 6 is a flow chart detailing the steps of a procedure 600 for reading data from a data archive storage system in accordance with an illustrative embodiment of the present invention. The procedure 600 begins in step 605 and continues to step 610 where a data access request is received from a client that seeks to read data stored on the data archive storage system. The SSDs within the storage system storing the requested data are then identified in step 615. Power is then applied to be identified SSDs in step 620. By utilizing the features of MLC SSDs, power only needs to be applied to a SSD while I/O operations are occurring to the SSD. This dramatically reduces the overall power requirements of a data archive storage system in accordance with an illustrative embodiment of the present invention.

The requested data is read from the identified the SSDs in step 625. This read operation may be performed using conventional read techniques for MLC SSDs. The read data is then decompressed in step 630. The decompression illustratively utilizes the technique to reverse the compression from step 415 of procedure 400, i.e., the same compression technique but utilized in the decompression mo. As will be appreciated by one skilled in the art, this may vary depending on the type of compression, e.g., symmetric, asymmetric, etc. If the data set was not encrypted when it was originally stored on the data archive storage system, there is no need to decompress the data and step 630 may be skipped.

Furthermore, the read data is then restored in step 635. As de-duplication is an optional step when the data set is originally written to the data archive storage system, step 635 is optional. The requested data, which is now in its decompressed and restored form (i.e., its original format), is then returned to the client in step 640. This may be accomplished by, e.g., the creation of an appropriate message by the network protocol stack 210 to forward the requested data over network 160. The SSDs that were powered up are then powered down in step 645. The procedure 600 then completes in step 650.

The foregoing description has been directed to specific embodiments of this invention. It will be apparent, however, that other variations and modifications may be made to the described embodiments, with the attainment of some or all of their advantages. For instance, it is expressly contemplated that the components and/or structures described herein can be implemented as software, including a computer-readable medium having program instructions executing on a computer, hardware, firmware, or a combination thereof. Furthermore, each of the modules may be implemented in software executed on a programmable processor, hardware or a combination of hardware and software. That is, in alternative embodiments, the modules may be implemented as logic circuitry embodied, for example, within a microprocessor, controller, e.g., a programmable gate array or an application specific integrated circuit (ASIC). Accordingly this description is to be taken only by way of example and not to otherwise limit the scope of the invention. Therefore, it is the object of the appended claims to cover all such variations and modifications as come within the true spirit and scope of the invention.

What is claimed is:

1. A data archive storage system comprising:
an array of multi-level cell flash devices operative interconnected with a processor configured to execute a storage operating system comprising a file system, the file system configured to, in response to receipt of a data set for storage on the data archive storage system, (i) de-duplicate the received data set, (ii) compress the received data set and (iii) store the received data set in the array of multi-level cell flash devices.

2. The data archive storage system of claim 1 wherein the file system is further configured to, in response to receipt of a request for data, (iv) identify one or more of the multi-level cell flash devices that store the requested data, (v) apply power to the identified multi-level cell flash devices, (vi) read the requested data from the identified multi-level cell flash devices and (vii) remove power from the identified multi-level cell flash devices.

3. The data archive storage system of claim 2 wherein the file system is further configured to (viii) decompress the read requested data and (ix) restore the read requested data.

4. The data archive storage system of claim 1 wherein the data set comprises a backup data stream.

5. The data archive storage system of claim 1 wherein the de-duplication comprises:
chunking the received data set into a plurality of blocks;
generating a signature for each of the plurality of blocks;
determining whether the generated signature is in a signature database;
in response to determining that the generated signature is in the signature database, replacing a block with the generated signature with a pointer to a previously stored block with the generated signature; and
in response to determining that the generated signature is not in the signature database, placing the generated signature in the signature database and storing the block with the generated signature.

6. A data archive storage system comprising:
an array of multi-level cell flash devices operatively interconnected with a processor configured to execute a storage operating system comprising a file system, the processor operatively interconnected with a flash controller configured to control power to the array of flash devices in response to commands from the storage operating system, and wherein the file system is configured to (i) receive a data set, (ii) de-duplicate the received data set and (iii) store the de-duplicated data set in the array of multi-level cell flash devices.

7. The data archive storage system of claim 6 wherein the file system is further configured to (iv) identify a set of multi-level cell flash devices of the array of multi-level cell flash devices that stores data requested by a data access request, (v) read the requested data, (vi) restoring the read requested data and (vii) return the read requested data.

8. The data archive storage system of claim 7 wherein the set of multi-level cell flash devices of the array of multi-level cell flash devices that stores data requested by the data access request are powered on by the flash controller prior to being read.

9. The data archive storage system of claim 7 wherein the set of multi-level cell flash devices of the array of multi-level cell flash devices that stores data requested by the data access request are powered down by the flash controller after the data requested by the data access request is read.

10. The data archive storage system of claim 6 wherein the de-duplication comprises:
chunking the received data set into a plurality of blocks;
generating a signature for each of the plurality of blocks;
determining whether the generated signature is in a signature database;
in response to determining that the generated signature is in the signature database, replacing a block with the generated signature with a pointer to a previously stored block with the generated signature; and
in response to determining that the generated signature is not in the signature database, placing the generated signature in the signature database and storing the block with the generated signature.

11. A data archive storage system comprising:
an array of multi-level cell flash devices operatively interconnected with a processor configured to execute a storage operating system comprising a file system, the processor operatively interconnected with a flash controller configured to control power to the array of flash devices in response to commands from the storage operating system, and wherein the file system is configured to (i) receive a data set, (ii) compress the received data set and (iii) store the compressed data set in the array of multi-level cell flash devices.

12. The data archive storage system of claim 11 wherein the file system is further configured to (iv) identify a set of multi-level cell flash devices of the array of multi-level cell flash devices that stores data requested by a data access request, (v) read the requested data, (vi) decompress the read requested data and (vii) return the read requested data.

13. A method for execution on a data archive storage system comprising:
receiving a data set for storage on the data archive storage system;
performing a de-duplication procedure on the received data set;
compressing the de-duplicated data set;
storing the compressed data set on an array of multi-level cell flash devices;
receiving a read request from a client of the data archive storage system directed to the stored data;
determining, by a controller, a set of multi-level cell flash devices storing the requested data;
applying power to the set of multi-level cell flash devices;
reading the requested data from the set of multi-level cell flash devices;
decompressing the read requested data;
restoring the decompressed data;
responding to the read request; and
removing power to the set of multi-level cell flash devices.

14. The method of claim 13 wherein the de-duplication procedure comprises chunking the received data set into a plurality of predefined sized blocks.

15. The method of claim 13 wherein the data set comprises a backup data stream.

16. The method of claim 13 wherein compressing the de-duplicated data set comprises utilizing a symmetric compression technique.

17. The method of claim 13 wherein the de-duplication procedure comprises:
chunking the received data set into a plurality of blocks;
generating a signature for each of the plurality of blocks;
determining whether the generated signature is in a signature database;
in response to determining that the generated signature is in the signature database, replacing a block with the generated signature with a pointer to a previously stored block with the generated signature; and
in response to determining that the generated signature is not in the signature database, placing the generated signature in the signature database and storing the block with the generated signature.

18. A method comprising:
receiving a data set from a client for storage on a data archive storage system, wherein the data archive storage system comprises a processor operatively interconnected with a controller configured to control an array of multi-level cell flash devices;
de-duplication, by one or more modules of a storage operating system executing on the processor, the received data set; and
storing, by the controller, the de-duplicated data set on the array of multi-level cell flash devices.

19. The method of claim 18 further comprising compressing the received data set.

20. The method of claim 19 wherein compressing the received data set comprises utilizing a symmetric compression technique.

21. The method of claim 18 wherein de-duplicating the received data set comprises:
chunking the received data set into a plurality of blocks;
generating a signature for each of the plurality of blocks;
determining whether the generated signature is in a signature database;
in response to determining that the generated signature is in the signature database, replacing a block with the generated signature with a pointer to a previously stored block with the generated signature; and
in response to determining that the generated signature is not in the signature database, placing the generated signature in the signature database and storing the block with the generated signature.
